(19) United States
(12) Patent Application Publication
(10) Pub. No.: US 2008/0040945 A1
(43) Pub. Date: Feb. 21, 2008

(54) Mobile vacuum boring, cleaning & multi-tool utility power plant

(76) Inventor: Lynn A. Buckner, Chickamauga, GA (US)

Correspondence Address: LYNN A. BUCKNER, P.O. Box 609, Chickamauga, GA, 30707, US

(21) Appl. No.: 11/809,957

(22) Filed: Jun. 4, 2007

Related U.S. Application Data
(63) Continuation-in-part of application No. 11/208,565, filed on Aug. 22, 2005.
Application No. 11/208,565 is a continuation-in-part of application No. 10/217,055, filed on Aug. 12, 2002, now Pat. No. 6,988,568.
(60) Provisional application No. 60/810,747, filed on Jun. 5, 2006.
(60) Provisional application No. 60/814,791, filed on Jun. 20, 2006.
(60) Provisional application No. 60/814,721, filed on Jun. 20, 2006.

(51) Int. Cl. F26B 5/04

(52) U.S. Cl. 34/406

(57) ABSTRACT

The present invention relates to a mobile vacuum excavating, cleaning, demolition, cutting, & drilling machine which has on board a utility power generating means to power tools requiring pressurized water, air vacuum, hydraulic pressure, compressed air, AC power, DC power, water heater or welding means. In addition, this patent includes an a hydraulic cylinder with a check valve & control arrangement which will keep hydraulic pressure on the cylinder to keep it retracted even after the hydraulic supply is turned off, a mobile splash guard that is manually placed in around area to be excavated, a user friendly jack hammer stand which stores a jack hammer, or rock drill in an easy accessible manner, a rolled vibrating screen mounted inside the debris tank mounted on a slope with the filtered liquid exit opening positioned to seal against the vacuum tank access door, an electric powered wheel chair with a floor cleaning and floor surface preparation tool attached, a mobile satellite vacuum container which is used for filing, transporting & emptying vacuum able solids & liquids, and an articulated boom arm having one or more horizontal arms and pivot shafts in conjunction with one or more vertically articulated arms.

This application claims the benefits of provisional application No. 60/810,747 filed Jun. 5, 2006, and claims the benefits of provisional application No. 60/814,791 filed Jun. 20, 2006, and claims the benefits of provisional application No. 60/814,721 filed Jun. 20, 2006. This application is a CIP of Non-Provisional application Ser. No. 11/208,565 filed Aug. 22, 2005. Said Non-Provisional application Ser. No. 11/208,565 filed Aug. 22, 2005 is a CIP of it's Parent application Ser. No. 10/217,055 filed 12 Aug. 2002 to include it's 24 Sep. 2002 & 12 Mar. 2003 amendment and U.S. Provisional Application No. 60/363,058 filed on 11 Mar. 2002 and U.S. Provisional Application No. 60/384,719 filed on 3 Jun. 2002.

### BACKGROUND OF THE INVENTION

1. Field of the Invention

The present invention relates to a mobile vacuum excavating, cleaning, demolition, cutting, & drilling machine which has on board utility power generating means to power tools requiring pressurized water, air vacuum, hydraulic pressure, compressed air, AC power, DC power, water heater or welding means. In addition to providing a multi-utility mobile power plant, this patent includes an innovative wafer style valve to use in a vacuum conduit for diverting the air flow or stopping the air flow. The vacuum wafer valve can be used on a single conduit or on a multiple conduits manifold. The Vacuum wafer valve may be operated manually or by automated power. This invention also includes a mobile splash guard that is manually placed in around area to be excavated. This invention also includes a user friendly jack hammer stand which stores a jack hammer, or rock drill in an easy accessible manner. This invention also includes a hydraulic cylinder with a check valve & control arrangement which will keep hydraulic pressure on the cylinder to keep it retracted even after the hydraulic supply is turned off. This Hydraulic cylinder arrangement is used to close the Vacuum tank access door add to keep it sealed shut even after the hydraulic power supply is turned off. This invention also includes a rolled vibrating screen mounted inside the debris tank mounted on a slope with the filtered liquid exit opening positioned to seal against the vacuum tank access door. This arrangement provides access to pump filtered liquid out of the filter through an access orifice in the vacuum tank access door. This arrangement also provides access to the inside of the filter for cleaning when the vacuum tank access door is opened. This invention also includes an electric powered wheel chair with a floor cleaning and floor surface preparation tool attached. An umbilical cord may be attached between the mobile vacuum power plant and the powered wheel chair floor cleaner. The umbilical cord may attach vacuum, water pressure, electrical power, hydraulic power or air pressure to be used by the powered wheel chair surface cleaning system. This invention also includes an articulated boom arm having one or more horizontal arms and pivot shafts in conjunction with on or more vertically articulated arms. This mobile Vacuum method comprising a device which will create a vacuum condition within a vacuum container. The vacuum container may be mounted horizontally & then be raised to empty or the vacuum container may be mounted on a sufficient incline to allow debris to be emptied out by gravity and to provide space beneath the debris tank to locate a water storage container. The vacuum container may have a vacuum conduit to transport a liquid and or solid particles into the vacuum container. A dispensing device may be added to dispense a liquid or a solid from the vacuum container without eliminating the vacuum environment within the vacuum container, and said vacuum container may have the ability to fill, store and dispense its contents simultaneously. The vacuum container may further comprises a means to separate a liquid and from solids. Said vacuum conduit articulated boom used to transport debris into the vacuum container may have the added feature or attachments chosen from an earth digging bucket, a telescoping vacuum conduit, sensor to locate buried utilities, monitors and controls to remote operate the attachments and their function, such as a water spray nozzle, man hole cover remover, cutting tool, grinding tool, saw, blasting tool, surface cleaning tool, demolition tool, torque wrench, tractor to pull vacuum hose, jetter nozzle, or camera and power source to operate them. The above described vacuum system may be mounted on a variety of mobile platforms, chosen from but not limited to a trailer, truck, skid steer, fork lift, track hoe, railroad car, or zero turn radius vehicle which may have the added feature of being convertible between a powered vehicle & a trailer.

2. Background of the Invention

Current state of the art mobile vacuum boring and mud recovery systems have a limited use because vacuum containers capable of vacuuming mud and boring earth are operated as a batch process. They vacuum solids & liquids into the Vacuum container until the vacuum tank is full. Then the mobile vacuum system is used as a dump truck to carry the contents to a suitable dump site for a solids/liquid slurry. After the container is emptied, the mobile vacuum system is hauled back to the work site, the vacuum producing device may be restarted and the filling and storing may restart. These mobile vacuum systems are limited to using air pressure or water pressure to make solids vacuum able. To date it has not been realistic to depend on these mobile vacuum units for the support of other work activity because they were constantly leaving & returning.

The primary objective of the present invention is to provide a means to accomplish a compact, mobile multifunctional utility power plant to support a variety of work task simultaneously. The power plant may include power producing means for a Vacuum system, pressurized water, air vacuum, hydraulic pressure, compressed air, AC power, DC power, AC inverter or welding means. The mobile vacuum power plant will also include easy access to stored work tools and may be operated by remote control.

It is yet another objective of the present invention to provide a means to accomplish a compact, concentrated weight, vacuum boring & excavation system by creating a vacuum container mounted at a sufficient incline to allow debris to be emptied out by gravity and to provide space beneath the debris tank to locate a water storage container.

It is yet another objective of the invention is to provide a means of separating the stored contents by predetermined category and dispensing them without stopping the vacuum fill and store operation or eliminating the vacuum environment within the vacuum container.

It is yet another objective of the present invention to provide an articulated powered vacuum conduit boom with sufficient structural strength to allow an operator to move and control the location of the suction end of the vacuum conduit and said suction end of said vacuum conduit have an earth digging bucket mounted adjacent it, and said conduit boom with said earth digging bucket being mounted on a mobile vehicle, and a preferred vehicle being a powered zero turn radius vehicle having the ability to be converted into a tow able trailer configuration for the purpose of transporting from job to job.

It is yet another objective of the present invention to provide a vacuum conduit boom with sufficient structural strength, power and articulated movement to allow an operator to move and control the location of the suction end of the vacuum conduit into a manhole lateral line along with a jetter spray nozzle.

It is yet another objective of the present invention to provide an articulated powered vacuum conduit boom with sufficient structural strength to allow an operator to remotely move and control the location of the suction end of the vacuum conduit with one or more attachments adjacently attached to the boom arm, and said attachments being chosen from an earth digging bucket, a telescoping vacuum conduit, sensor to locate buried utilities, monitors and controls to operate the attachments and their function, water spray nozzle, manhole cover remover, cutting tool, grinding tool, saw, blasting tool, surface cleaning tool, demolition tool, torque wrench, tractor to pull vacuum hose, jetter nozzle, or camera and power source to operate them. The boom is to also have user friendly connections for both the attachment & the power utility needed to power said tool.

It is yet another objective of the present invention to separate hydrocarbons from the contents vacuumed into the vacuum container.

It is yet another objective of the present invention to provide a means to purify or sterilize the contents vacuumed into the vacuum tank.

It is yet another objective of the present invention to provide an efficient powered mechanical means of dislodging the solids from the vacuum debris tank so that gravity will unload them.

It is yet another objective of the present invention to provide a compact wafer style bolt together vacuum conduit valve to be used to valve off the flow of air in a vacuum line or to select air flow between two or more vacuum conduit lines.

It is yet another objective of the present invention to provide an electric powered wheel chair with a floor cleaning and floor surface preparation tool attached. An umbilical cord may be attached between the mobile vacuum power plant and the powered wheel chair floor cleaner. The umbilical cord may attach vacuum, water pressure, electrical power, hydraulic power or air pressure to be used by the powered wheel chair surface cleaning system

It is yet another objective of the present invention to provide a rolled vibrating screen mounted inside the debris tank and mounted on a slope with the filtered liquid exit opening positioned to seal against the vacuum tank access door. This arrangement provides access to pump filtered liquid out of the filter through an access orifice in the vacuum tank access door. This arrangement also provides access to the inside of the filter for cleaning when the vacuum tank access door is opened.

It is yet another objective of the present invention to provide a mobile splash guard that is manually placed around an area to be excavated.

It is yet another objective of the present invention to provide a user friendly jack hammer stand which stores a jack hammer, or rock drill in an easy accessible manner.

It is yet another objective of the present invention to provide a hydraulic cylinder with a check valve & control arrangement which will keep hydraulic pressure on the cylinder to keep it retracted even after the hydraulic supply is turned off. This Hydraulic cylinder arrangement is used to close the Vacuum tank access door add to keep it sealed shut even after the hydraulic power supply is turned off.

It is yet another objective of the present invention to provide a remote controlled water jetter to clean pipe lines & a vacuum conduit to vacuum up the pipe line debris.

It is yet another objective of the present invention to provide a auxiliary mobile trailer mounted vacuum tank for loading, hauling and dumping of vacuumed solids & liquids. Other than an onboard battery operated hydraulic dump system, the vacuum & other required utilities will be supplied from the mother power plant by way of a utility umbilical cord.

It is yet another objective of the present invention to provide a mobile satellite vacuum container which is used for filing, transporting & emptying vacuum able solids & liquids. The mobile satellite vacuum container gets it's vacuum by connection a hose to the mobile power plant which is located on a different vehicle

### SUMMARY OF THE INVENTION

The above described objectives and others are met by a method comprising a device which will create a vacuum condition within a vacuum container and the vacuum container being mounted on a sufficient incline to allow debris to be emptied out by gravity and to provide space beneath the debris tank to locate a water storage container and having a vacuum conduit to transport liquid and or solid particles into the vacuum container or the vacuum container may be mounted horizontally and then raised to operate or empty. A water tank may be mounted adjacent to the vacuum container. A dispensing device may be added to dispense a liquid or a solid from the vacuum container without eliminating the vacuum environment within the vacuum container, and said vacuum container having the ability to fill, store and dispense its contents simultaneously. The vacuum container may further comprise a means to separate a liquid from solids. A rolled vibrating screen mounted inside the debris tank mounted on a slope with the filtered liquid exit opening positioned to seal against the vacuum tank access door. This arrangement provides access to pump filtered liquid out of the filter through an access orifice in the vacuum tank access door. This arrangement also provides access to the inside of the filter for cleaning when the vacuum tank access door is opened. The vibration of the screen creates a continuous cleaning of the screen & causes it to resist blinding out or clogging. Solids do not adhere well to a moving surface. The vibrations help to remove water from the solids, but also compacts and solidify the solids. The solids may becomes too hard to remove from the tank by gravity alone. Therefore a drag bar, blanket, mesh screen, cable or chain may be placed so as to be imbedded within the solids as they accumulate. Said drag bar, blanket, mesh screen, cable, or chain may be connected to the vacuum container access door, and as the door is opened, the solids are dragged from the tank, out through the door threshold. Once the solids begin to move, thus breaking the surface tension between the solids & the debris tank wall, the dislodged solids are free to fall to the ground by gravity. Once the solids unloading is accomplished, the mechanical drag means may be pushed back into the debris tank provided the drag is ridged & can be pushed. By attaching the drag bar to the vacuum container access door a powered telescoping cylinder means may be used to open or close the door & simultaneously move the solids drag bar. The telescoping cylinder means may be a linear actuator or a hydraulic cylinder with a check valve & control arrangement which will keep hydraulic pressure on the cylinder to keep it retracted even after the hydraulic supply is turned off. This hydraulic cylinder arrangement is used to close the vacuum container access door and to keep it sealed shut even after the hydraulic power supply is turned off.

Solids & liquids are vacuumed into the vacuum tank through a vacuum conduit. On occasion there is need to stop the vacuum air flow or to select between multiple vacuum conduits entering the vacuum tank. A smaller diameter vacuum conduit may be available for light hand use by an operator and a larger diameter heavy vacuum conduit mounted on a boom. A remote control system may select a compact bolt together vacuum wafer valve mounted in the vacuum conduit lines to open or close, thus choosing the use of one vacuum conduit over the other. The valve may also be used as a safety shut off to avoid vacuuming up an item by accident. The flat surface style bolt together wafer valve is efficient to manufacture sense all parts are cut from flat plat with no machining required. They also require minimum labor to assemble or clean.

This mobile vacuum system further comprises the steps of adding a multiple utility power plant in order to provide vacuum, water pressure, hydraulic pressure, air pressure, AC electric power, DC electric power, water heater, and a welder. These utilities provide power to allow multiple operators to simultaneously perform different work task with a wide variety of tools chosen from but limited to a jack hammer, rock drill, concrete saw, hand held drill, powered wrenches, torque wrench, sanders, sand blasting, welding, jettering, vacuum excavation, digging bucket, dirt emulsification, electric powered wheel chair with surface cleaning & surface cleaning preparation tools attached, or a auxiliary trailer mounted vacuum dump tank. A vacuum container which is used for filing, transporting & emptying vacuum able solids & liquids may be mounted on a trailer or truck that does not have a vacuum source on board. In this case only mobile transporting power & dumping power are requires on board the vehicle. If the vacuum container which is used for filing, transporting & emptying vacuum able solids & liquids is mounted on a trailer, no power so is required on board because the vehicle pulling the trailer may supply power for dumping the container. The mobile satellite vacuum container gets it's vacuum by connection a hose to the mobile power plant which is located on a different vehicle

The utilities may use manual or powered hose or cord reels. The storage reels may be operated by remote control. One or more articulated boom arms may be utilized to support utility hoses or cords as well as to attach & articulate tools. The booms may be counter balanced or powered and may have one or more arms which move in a horizontal or vertically.

An articulated powered vacuum conduit boom may be of sufficient structural strength to allow an operator to remotely move and control the location of the suction end of the vacuum conduit with one or more attachments adjacently attached to the suction end of said vacuum conduit and said attachments being chosen from an earth digging bucket, a telescoping vacuum conduit, sensor to locate buried utilities, monitors and controls to operate the attachments an their function, water spray nozzle, manhole cover remover, cutting tool, grinding tool, saw, blasting tool, surface cleaning tool, demolition tool, torque wrench, tractor to pull vacuum hose, jetter nozzle, or camera and power source to operate them.

### BRIEF DESCRIPTION OF THE DRAWINGS

FIG. 1 shows a vacuum container according to a first embodiment of the invention having a utility power plant consisting of an engine, hydraulic pump, vacuum pump, water pump, water heater, air compressor, DC generator, AC generator, and welder. The power plant is shown to supple hydraulics to a jack hammer which has been removed from it's jack hammer stand. A vacuum container is shown mounted at an incline angle with water storage below. A hydraulic cylinder with check valve controls is shown holding the vacuum container access door closed. A compact wafer style valve is shown being used to select use between one or the other vacuum conduits. One vacuum conduit is shown to be attached to an electric wheel chair which in turn is attached to a floor surface cleaner which is shown to clean with pressurized hot water and vacuum is shown to recover the water along with the dirt. A second larger vacuum conduit is shown being articulated by a remote controlled powered boom. The second vacuum conduit is shown to be excavating with pressurized water and vacuum using a combination vacuum/water nozzle digging head. A splash guard is shown around the excavation hole. Three separate work activities are shown taking place simultaneously.

FIG. 1A shows a Jack hammer stand 135 mounted adjacent to the trailer 30 frame. The stand 135 is purposely located with its base 131 being located below the elevation of the trailer 30 frame. This positioning is chosen in order to place the handles of the jack hammer 140 at approximately waste high on a man standing to remove the jack hammer. A curling movement of the mans elbows will lift the jack hammer 140 from its stand 135. An attachment rod 130 that customarily fits into the Jack hammer is securely attached to a support frame 136. The support frame 136 is then securely attached to the trailer 30 frame by a fastener means 137. a latch 139 may be hinged 138 to the support frame 136 in order to latch the jack hammer 140 in place during transport.

FIG. 2 Shows the side view if an articulated boom arm. #202 is a horizontal arm useful to rotate the vertical arm 205 to a position on one sides or the other of the mobile vehicle on which the boom is mounted. Support shaft 201 mounts the boom to a vacuum Container vehicle and support shaft 203 is useful to rotate horizontally support bracket 204 which supports arm 205 and a powered linear actuator 208. The linear actuator 208 attached at one end to 204 is shown raising boom arm 205 vertically on pivot shaft 205A. Linear actuator 208 which is attached to boom arm 206 is used to extend the length of the boom arm. A counter balance air spring 212 is shown between the vertical lifting actuator 208 and the boom arm 205. The boom arm 206 has an attachment means 207 to mount & support auxiliary tools. In this example a hydraulic hose 210 supplies power to a submergible pump 211 and to a hydraulic torque wrench 213. A GPS means 214 is mounted on the tool in order to document the location of work being performed.

FIG. 3A-E comprised detail drawing of a compact bolt together vacuum conduit valve 325. FIG. 3A Shows a side view showing a stub section of vacuum conduit 314 attached to the outer wafer 311. The center wafer 304 is shown.

FIG. 3B shows a cut away view showing the pivot able knife valve plate 305 pivoting on shaft bolt 306. The handle 307 portion of knife plate 305 is used as leverage to move the valve. A cylinder 313 is shown to be used to move valve handle 307/305 in order to open or close a given conduit orifice 314. Cylinder 313 is attached at pivot bolt 312 to the outer plates 311. Cylinder 313 is attached at pivot bolt 308 to the valve handle 307. A center seal plate 304 is shown.

FIG. 3C shows a side view of seal plate 304

FIG. 3D shows a side view of the knife plate valve 307 and its handle 307 & pivot shaft hole 306. 308 hole is used to attach a powered actuator cylinder.

FIG. 3E shows a side view of the two outer plates 311 and it shows bolt 310 used to assemble the plated by use of holes 309. Hole 306 is located for use as a pivot shaft for 305.

FIG. 4A-B show the side view of a splash guard which may be placed around an area to be excavated.

FIG. 4A shows a vacuum conduit 17 with its water pressure hose 5 excavating a hole inside the perimeter of the splash guard housing 402. A handle 410 is shown attached to the housing 402. Spikes 403 are shown attached to guard 402 in order to secure the assembly in the ground 35

FIG. 4B is similar to 4A but with the handles 410 & spikes 403 on the outside of guard 402 a support rim 404 may be added.

FIG. 5 Shows a side view if a floor surface cleaner 32 being washed with pressurized water 2. The surface cleaner 32 pressure washes & then vacuums up the water & dirt through vacuum conduit 17. Surface cleaner 32 is attached 501 to an electric motor 503 powered wheel 502 chair 73. An operator sitting in the powered wheel 502 chair 73 and uses a joy stick 506 to operates the movement of the cleaner 32 across the floor. A variety of floor surface sanders, floor polishers, or bead blasters attachments may be used in place of the surface cleaner 32. This configuration converts a powered wheel 502 chair 73 into a floor maintenance machine. The powered wheel 502 chair 73 may have an umbilical cord attached from it to a power source. FIG. 5 shows a vacuum conduit 17 attaching the surface cleaner 32 to the powered wheel 502 chair 73, and a continuation of the vacuum conduit 17 from the powered wheel 502 chair 73 on to a vacuum power source as shown in FIG. 1. A water pressure hose 5 is shown to parallel the course of the vacuum conduit 17. A battery 504 housing is shown as well as an electric power cord 505 which may get its power from a central vacuum power plant 76.

FIGS. 6A & B Shows the side view of the hydraulic cylinder (63) with a schematic of the hydraulic controls. Cylinder shell (601) holds hydraulic fluid in reservoir (604) for pressing against piston (603) to open the hydraulic cylinder. The clevis (615) and sleeve (616) are used to mount the cylinder (63). The front reservoir (605) controls opposing pressure on the piston (603) and piston rod (602) in order to retract cylinder rod 602. The hydraulic fluid flows through the inlets (606, 607) to conduit (608-610), the check valve (612), and flow limiters (611) to directional control valves by inlets (613, 614). Even after the hydraulic power supply is turned off, the check valve control 612 works in conjunction with pilot 609 to maintain pressure within the front reservoir 605 thus securing that piston rod 602 will not extend because of the loss of hydraulic pressure from the power supply. Thus this valve & cylinder arrangement is suited to secure a vacuum container 12 access door 18 sealed close even when the power plant 76 is not in operation.

FIG. 7 Shows a side view if a mobile vacuum container system similar to FIG. 1 except that in this view a solids 6/liquid 2 separating rolled screen 21 is shown mounted at an incline slope within a vacuum container 12. Two vibrators 23 are shown mounted within the rolled screen 21. To insure freedom to vibrate the screen 21 system is shown mounted on a flexible 22 foam sheet. A powered hydraulic cylinder 63 has pushed the vacuum tank 12 access door 18 open which has in turn pulled the solids drag bar 62, which had been imbedded in the solids 6, out of the vacuum container 12 along with the solids 6. An articulated powered boom as shown in FIG. 2 is mounted on to the lower end of the filter housing 64. A remote control antenna 209 is shown mounted on top of the power plant 76 enclosure. The functions of the boom and the opening of the rear door 18 are accomplished by a hand held remote control receiver/transmitter.

FIG. 8 Shows a cross sectional view of an earth excavator digging a hole in the earth using a vacuum container mounted on a zero-turn radius vehicle & having a solids and liquid separation and unloading means. The Vacuum container is shown connected to an articulated vacuum conduit boom with an earth digging bucket attached in the retracted position. A telescoping section of the vacuum conduit is shown in the extended position vacuuming dirt that has been by water sprayed from a liquid spray nozzle which is shown mounted in the outside circumference of an indention in the suction end of the vacuum conduit. The indention reduces the size of solid that can enter the vacuum conduit, thus reducing the frequency of solids being clogged in the vacuum conduit. The earth excavator is shown to be convertible between a zero turn radius vehicle and a tow able trailer. The excavator is shown in the excavating configuration. With the spreader blade being used as a jack. The debris access door is shown opening by a powered telescoping cylinder which in turn moves the pull bars and dried dirt out of the vacuum tank.

FIG. 9 Shows a cross section side view of an earth excavator as shown in FIG. 8 except that it is in the towing configuration as a trailer attached behind a truck. The trailer hitch 67 has been lowered & the swivel front wheels 68 have been raised. The articulated vacuum boom 36 has been configured into a stored position and the combination dirt pushing blade 66/jack has been raised. The vacuum container 12 access door 18 has been powered close by retracting hydraulic cylinder 63. The liquid dispensing pump 1 is shown mounted on the rear door 18 and also shows the pump 1 suction orifice access through the rear door 18 that provides access for the pump 1 to pump liquid 2 from within the vacuum container 12. a check valve 1B is shown located in the discharge of the pump 1. Check valve 1B allows the pump to share the same atmospheric conditions at that of the vacuum container 12. Because the pump 1 and the vacuum container 12 share the same atmospheric conditions the liquid 2 can flow naturally by gravity into the pump 1. A water jetter hose reel 37 is shown mounted to the rear door 18. The jetter reel may be powered and operated by remote control.

FIG. 10 Shows an inclined slope vacuum container supported by a liquid storage container mounted under the slope of the vacuum tank. A filter housing containing filters is shown mounted adjacent to the debris tank. A single door is shown to access both the filter house and the debris tank simultaneously. A powered telescoping cylinder or linear actuator is shown to open or close the access door. A powered articulating vacuum boom is shown with a manhole cover removal attachment.

FIG. 11 Is similar to FIG. 8 with the exception that a water pressure surface cleaner 32 is shown attached to the telescoping vacuum conduit 17. The powered articulating boom 36 is shown to be placing the surface cleaner 32 an a wall that is shown to need cleaning.

FIG. 12 Shows the side view of a Vacuum container mounted on a zero turn radius vehicle similar to drawing 8. A powered boom arm is shown placing a surface preparation tool 32 over a utility 15 to be excavated. A utility locating devise 33 is shown to be penetrating the earth to locate the utility 15. This system is shown to be multifunctional an provides the technology required to do excavating close to a utility without harming it.

FIG. 13 Shows a vacuum container 12 with liquid 2 and solid 6 dispensers according to an t embodiment of the invention using an articulated vacuum conduit 17 and jetter 37 boom to reach into a lateral line of a drain pipe 38. A vacuum conduit tractor 52 is shown pulling a vacuum conduit 17 & the tractor 52 is shown with a rotating 53 vacuum nozzle, controls, light and camera 52. A jetter 39 is also shown loosening debris to be vacuumed. The vacuum container 18 is shown to separate solids 6 & liquids 2. The liquid is shown to be dispensed and recycled. The solids are shown to be ground in a grinder 27 to a smaller size, and transported by a progressive cavity screw 10 to a mobile container 9. Propulsion jetter water 40 washes the debris 45 back to a mane hole 59.

FIG. 14 Shows yet another embodiment of the invention with the Vacuum container 12 operating horizontally. Solids 6 are being dispensed by dispensing means 10. The dispensed solids 6 are placed in a conveyor 49 to transport to another destination.

FIG. 15 shows on the right, a side view of a trailer 30 mounted power plant 76 which powers a vacuum pump and supplies a vacuum source for trailer 30 onboard vacuum container 12. Trailer 30TP is shown having a vacuum container 12TP but it does not have an onboard vacuum source. Trailer 30TP is used to transport vacuumed solids & liquids and is shown connected to a truck 70. This arrangement allows the multi-tool power-plant to remain on the job site while truck 70 hauls vacuum able materials off the job site in vacuum container 12TP. To fill vacuum container 12TP a vacuum conduit 17 is shown connected to vacuum container 12. Power plant 76 is also shown providing pressurized water 2 to the vacuum conduit 17 which is shown filling vacuum container 12TP. Vacuum container 12TP is shown to be able to be dumped by extending hydraulic cylinder 29. Container 12TP will pivot on axle 28.

FIG. 16 is a cross section side elevation of a vacuum hose 17 which may be used to vacuum excavated dirt or earthen material. The circumference wall of the vacuum hose 17 has been increased at the suction inlet to form a bell 91 shaped configuration. The bell circumference 91 is larger than the vacuum hose circumference 17 thus increasing the inlet area. An indention 92 is made into the bell circumference 91. The ratio between the vacuum hose circumference 17, the bell circumference 91 and the size of the indention 92, affects the area of the suction inlet of the vacuum hose 17 thus affecting the velocity of air and debris travel at that point. Various desired velocity characteristics may be achieved by manipulating the above mentioned ratios. Various debris 45 are vacuumed more effectively at different velocities thus the above mentioned ratios may be predetermined for best efficiency of a given debris 45 to be vacuumed.

The indention 92 may be sized so as to restrict the maximum size of debris 45 which may enter the vacuum hose 17 thus not allowing debris 45 to enter the vacuum hose 17 which would be so large as to clog the vacuum hose 17.

A liquid spray nozzle 26 which may be a pulse jet, a rotary jet, a jetter nozzle or a fixed spray jet may be placed in the indention 92. The indention 92 may be cone shaped so as to direct the nozzle 26 orifice 76 and liquid spray 2 in the direction of the center of the area to be vacuumed by the vacuum hose 17, thus the liquid spray 2 effectively loosens and makes vacuum able the dirt at the entrance of the suction end of the vacuum hose 17.

Liquid is supplied to the nozzle 26 by means of the spray nozzle hose 5.

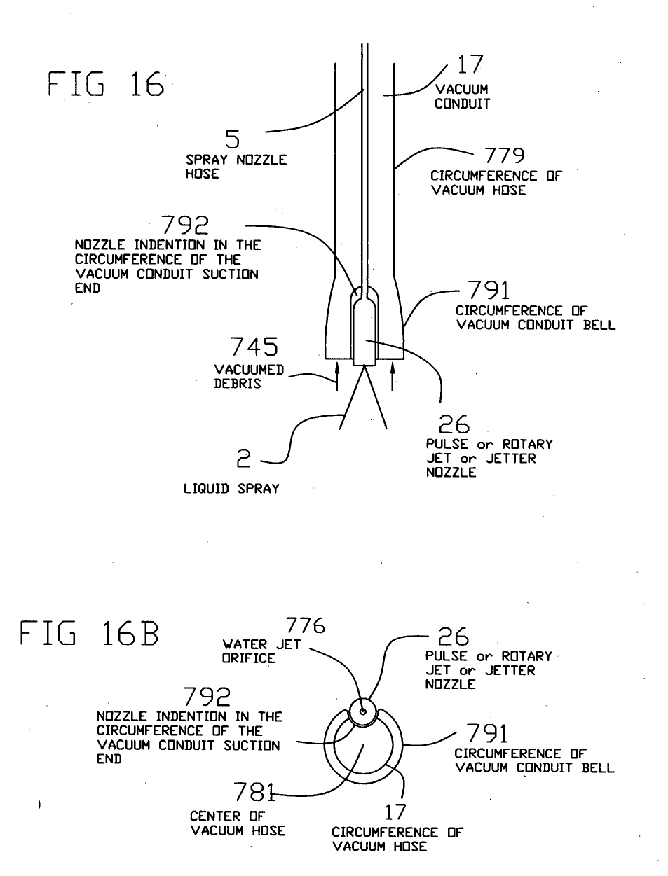

FIG. 16B is an end view of the suction end of the vacuum hose showing how the bell circumference 791 is indented 792 in order to restrict the debris 745 size entering the hose to less than the size of the vacuum hose circumference 17.

### DETAILED DESCRIPTION of the PREFERRED EMBODIMENTS

Using the drawings, the preferred embodiments of the present invention will now be explained.

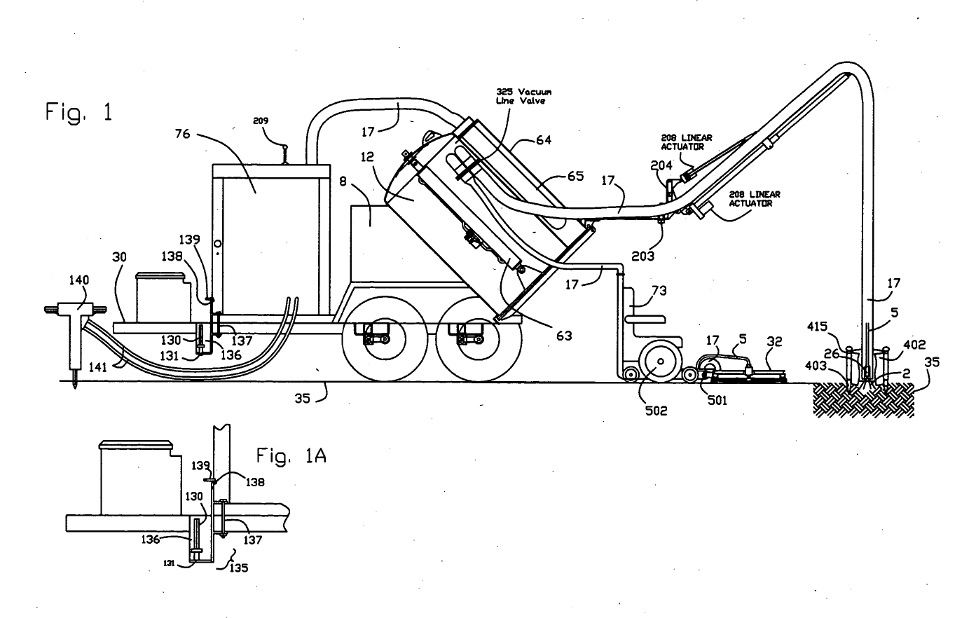

FIG. 1 shows a vacuum container according to a first embodiment of the invention having a utility power plant consisting of an engine, hydraulic pump, vacuum pump, water pump, water heater, air compressor, DC generator, AC generator, and welder. The power plant is shown to supple hydraulics to a jack hammer which has been removed from it's jack hammer stand. A vacuum container is shown mounted at an incline angle with water storage below. A hydraulic cylinder with check valve controls is shown holding the vacuum container access door closed. A compact wafer style valve is shown being used to select use between one or the other vacuum conduits. One vacuum conduit is shown to be attached to an electric wheel chair which in turn is attached to a floor surface cleaner which is shown to clean with pressurized hot water and vacuum is shown to recover the water along with the dirt. A second larger vacuum conduit is shown being articulated by a remote controlled powered boom. The second vacuum conduit is shown to be excavating with pressurized water and vacuum using a combination vacuum/water nozzle digging head. A splash guard is shown around the excavation hole. Three separate work activities are shown taking place simultaneously.

FIG. 1A shows a Jack hammer stand 135 mounted adjacent to the trailer 30 frame. The stand 135 is purposely located with its base 131 being located below the elevation of the trailer 30 frame. This positioning is chosen in order to place the handles of the jack hammer 140 at approximately waste high on a man standing to remove the jack hammer. A curling movement of the mans elbows will lift the jack hammer 140 from its stand 135. An attachment rod 130 that customarily fits into the Jack hammer is securely attached to a support frame 136. The support frame 136 is then securely attached to the trailer 30 frame by a fastener means 137. a latch 139 may be hinged 138 to the support frame 136 in order to latch the jack hammer 140 in place during transport. A lock, bungee cord, straps and other travel security means may be used.

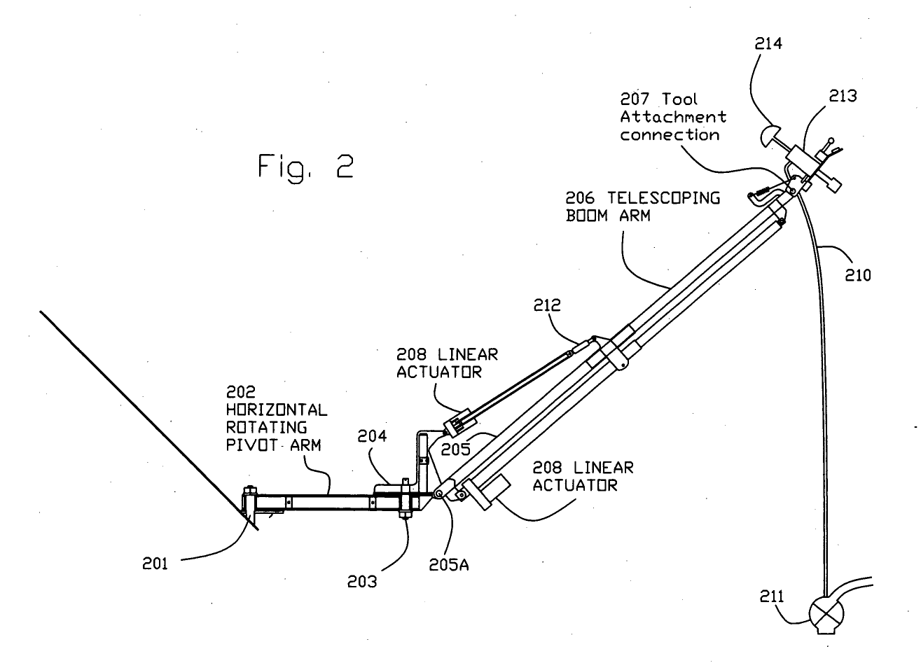

FIG. 2 Shows the side view if an articulated boom arm. #202 is a horizontal arm useful to rotate the vertical arm 205 to a position on one sides or the other of the mobile vehicle on which the boom is mounted. Support shaft 201 mounts the boom to a vacuum Container vehicle and support shaft 203 is useful to rotate horizontally support bracket 204 which supports arm 205 and a powered linear actuator 208. The linear actuator 208 attached at one end to 204 is shown raising boom arm 205 vertically on pivot shaft 205A. Linear actuator 208 which is attached to boom arm 206 is used to extend the length of the boom arm. A counter balance air spring 212 is shown between the vertical lifting actuator 208 and the boom arm 205. The boom arm 206 has an attachment means 207 to mount & support auxiliary tools. In this example a hydraulic hose 210 supplies power to a submergible pump 211 and to a hydraulic torque wrench 213. A GPS means 214 is mounted on the tool in order to document the location of work being performed.

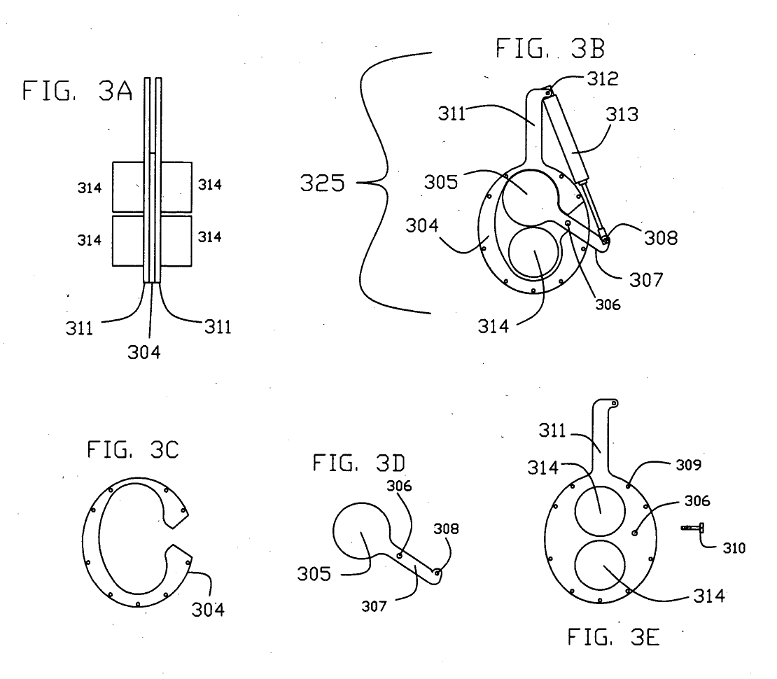

FIG. 3A-E comprised detail drawing of a compact bolt together vacuum conduit valve 325.

FIG. 3A Shows a side view showing a stub section of vacuum conduit 314 attached to the outer wafer 311. The center wafer 304 is shown.

FIG. 3B shows a cut away view showing the pivot able knife valve plate 305 pivoting on shaft bolt 306. The handle 307 portion of knife plate 305 is used as leverage to move the valve. A cylinder 313 is shown to be used to move valve handle 307/305 in order to open or close a given conduit orifice 314. Cylinder 313 is attached at pivot bolt 312 to the outer plates 311. Cylinder 313 is attached at pivot bolt 308 to the valve handle 307. A center seal plate 304 is shown.

FIG. 3C shows a side view of seal plate 301

FIG. 3D shows a side view of the knife plate valve 307 and its handle 307 & pivot shaft hole 306. 308 hole is used to attach a powered actuator cylinder.

FIG. 3E shows a side view of the two outer plates 311 and it shows bolt 310 used to assemble the plated by use of holes 309. Hole 306 is located for use as a pivot shaft for 305.

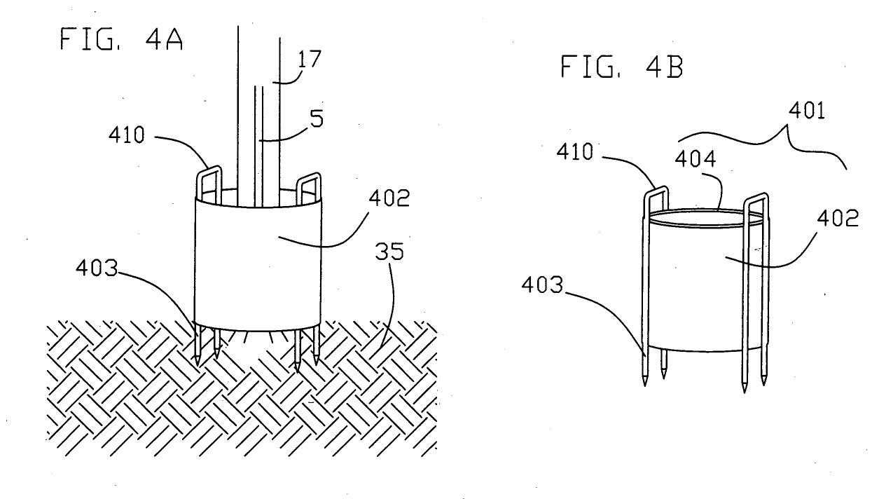

FIG. 4A-B show the side view of a splash guard which may be placed around an area to be excavated.

FIG. 4A shows a vacuum conduit 17 with its water pressure hose 5 excavating a hole inside the perimeter of the splash guard housing 402. A handle 410 is shown attached to the housing 402. Spikes 403 are shown attached to guard 402 in order to secure the assembly in the ground 35

FIG. 4B is similar to 4A but with the handles 410 & spikes 403 on the outside of guard 402 a support rim 404 may be added.

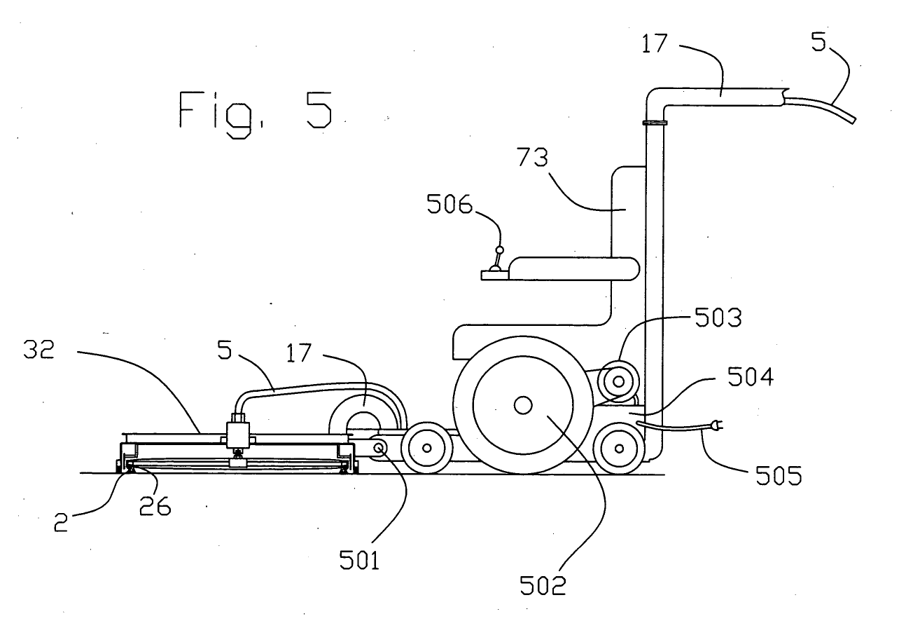

FIG. 5 Shows a side view if a floor surface cleaner 32 being washed with pressurized water 2. The surface cleaner 32 pressure washes & then vacuums up the water & dirt through vacuum conduit 17. Surface cleaner 32 is attached 501 to an electric motor 503 powered wheel 502 chair 73. An operator sitting in the powered wheel 502 chair 73 and uses a joy stick 506 to operates the movement of the cleaner 32 across the floor. A variety of floor surface sanders, floor polishers, or bead blasters attachments may be used in place of the surface cleaner 32. This configuration converts a powered wheel 502 chair 73 into a floor maintenance machine. The powered wheel 502 chair 73 may have an umbilical cord attached from it to a power source. FIG. 5 shows a vacuum conduit 17 attaching the surface cleaner 32 to the powered wheel 502 chair 73, and a continuation of the vacuum conduit 17 from the powered wheel 502 chair 73 on to a vacuum power source as shown in FIG. 1. A water pressure hose 5 is shown to parallel the course of the vacuum conduit 17. A battery 504 housing is shown as well as an electric power cord 505 which may get its power from a central vacuum power plant 76.

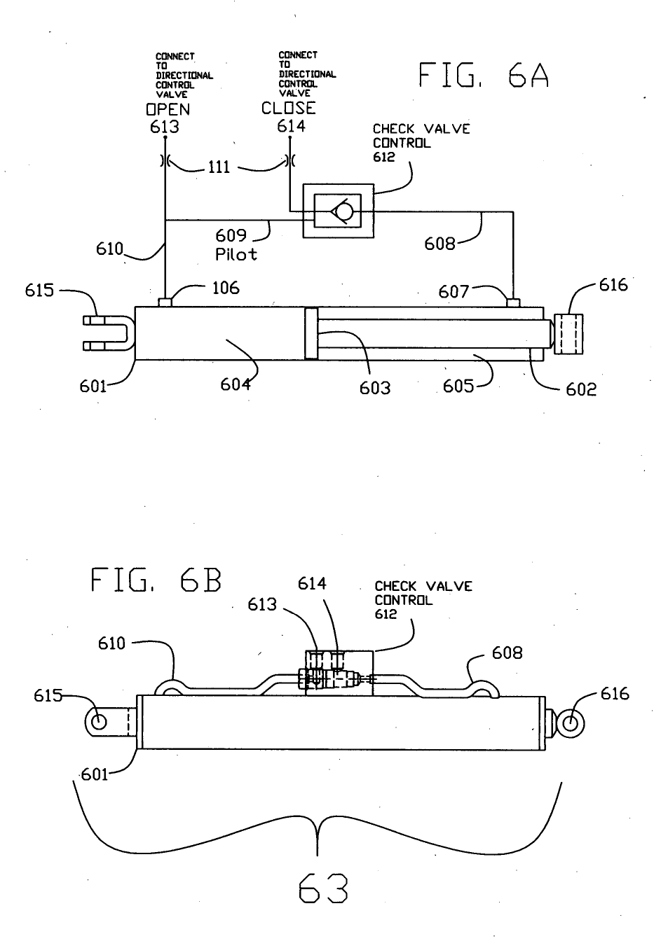

FIGS. 6A & B Shows the side view of the hydraulic cylinder (63) with a schematic of the hydraulic controls. Cylinder shell (601) holds hydraulic fluid in reservoir (604) for pressing against piston (603) to open the hydraulic cylinder. The clevis (615) and sleeve are used to mount the cylinder (63). The front reservoir (605) controls opposing pressure on the piston (603) and piston rod (602) in order to retract cylinder rod 602. The hydraulic fluid flows through the inlets (606, 607) to conduit (608-610), the check valve (612), and flow limiters (611) to directional control valves by inlets (613, 614). Even after the hydraulic power supply is turned off, the check valve control 612 works in conjunction with pilot 609 to maintain pressure within the front reservoir 605 thus securing that piston rod 602 will not extend because of the loss of hydraulic pressure from the power supply. Thus this valve & cylinder arrangement is suited to secure a vacuum container 12 access door 18 sealed close even when the power plant 76 is not in operation.

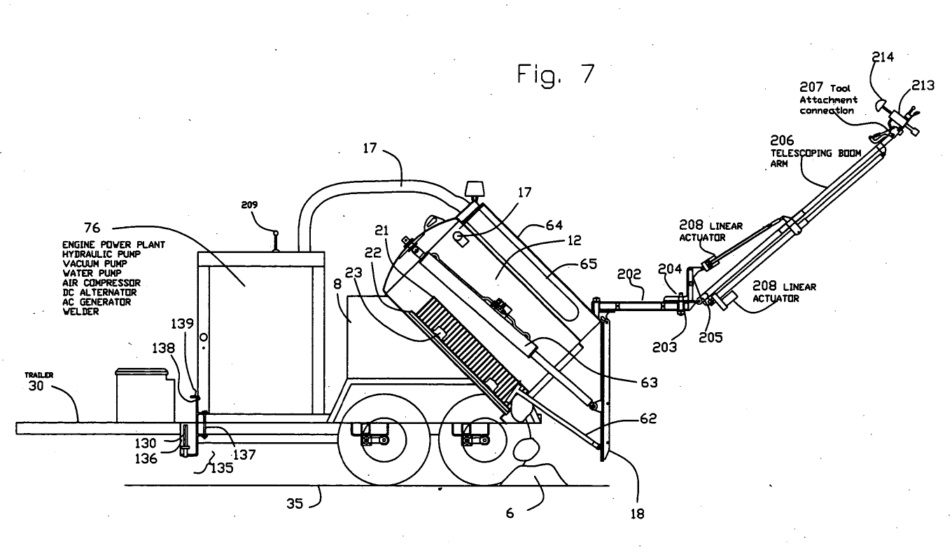

FIG. 7 Shows a side view if a mobile vacuum container system similar to FIG. 1 except that in this view a solids 6/liquid 2 separating rolled screen 21 is shown mounted at an incline slope within a vacuum container 12. Two vibrators 23 are shown mounted within the rolled screen 21. To insure freedom to vibrate the screen 21 system is shown mounted on a flexible 22 foam sheet. A powered hydraulic cylinder 63 has pushed the vacuum tank 12 access door 18 open which has in turn pulled the solids drag bar 62, which had been imbedded in the solids 6, out of the vacuum container 12 along with the solids 6. An articulated powered boom as shown in FIG. 2 is mounted on to the lower end of the filter housing 64. A remote control antenna 209 is shown mounted on top of the power plant 76 enclosure. The functions of the boom and the opening of the rear door 18 are accomplished by a hand held remote control receiver/transmitter.

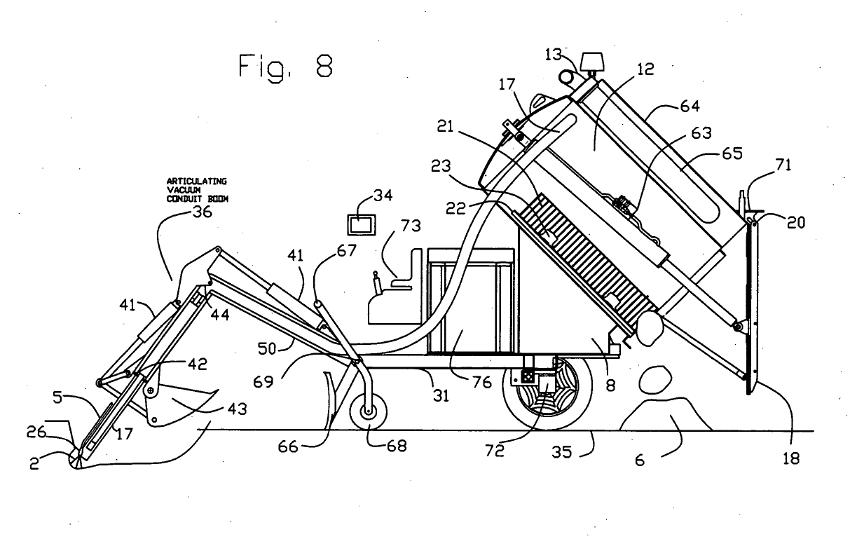

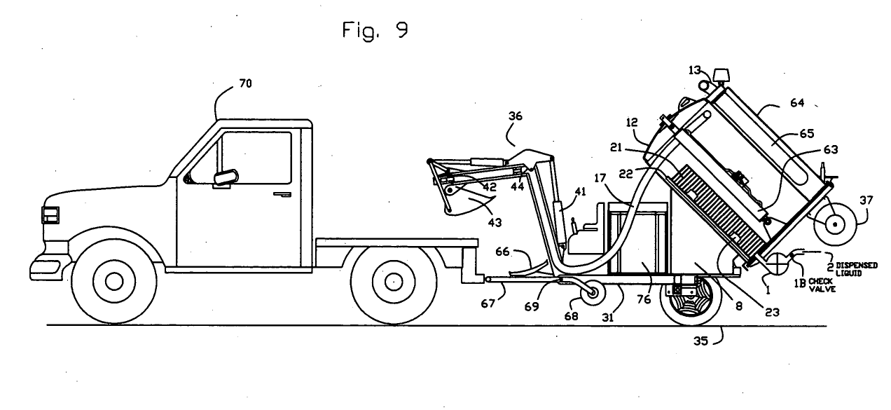

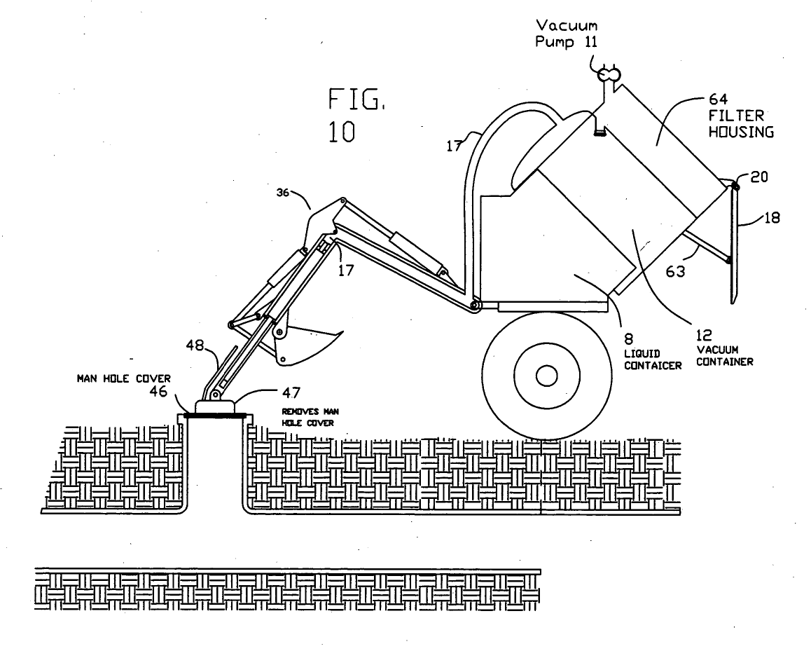

FIG. 8 Shows a cross sectional view of an vacuum boring & mood recovery unit digging a hole in the earth 35 using a vacuum container 12 mounted on a zero-turn radius vehicle 31 & having a solids 6 and liquid 2 separation means being a vibrating screen 21 and solids unloading drag bar 62 means. The Vacuum container 12 is shown connected to an vacuum conduit 17 articulated boom 36 with an earth digging bucket 43 attached in the retracted position. A telescoping section 42 of the vacuum conduit 17 is shown in the extended position vacuuming dirt 6 that has been emulsified by water 2 sprayed from a liquid spray nozzle 26 which is shown mounted in the outside circumference of an indention 75 in the suction end of the vacuum conduit 17. The indention reduces the size of solid 6 that can enter the vacuum conduit 17, thus reducing the frequency of solids 6 being clogged in the vacuum conduit 17. The earth excavator is shown to be converted from a self propelled zero turn radius vehicle 31 to a tow able trailer, by using the scrapper blade 66 as a jack to raise the front swivel wheels 68 of the ground 35. As shown in FIG. 10 the front swivel wheels 68 may be raised and the tow bar tongue 67 may be lowered thus readying the unit for towing as shown in FIG. 9. The excavator is shown in the excavating configuration. With the spreader blade 66 being used as a jack to sturdy the machine while digging. The debris access door 18 is shown opening by a powered telescoping cylinder 63 which in turn moves the pull bars 62 and dried dirt 6 out of the vacuum tank 12. In this illustration the water tank 8 and the power plant 76 which may include an engine, hydraulic motor, vacuum pump, air compressor, water pump, muffler or controls, are both positioned beneath the slope of the inclined slope vacuum container 12 thus creating an even more compact vacuum boring & mud recovery system with an even greater concentration of weight. The water tank 8 is shown supporting the vacuum container 12. The operator controls the device from the operator seat 73. Control center 34 includes means to control solids 6 liquid 2 separation & recycling, functions of excavation, location & avoidance of utilities, mapping of work area, recording of performance.

FIG. 9 shows the device in towing position behind a towing vehicle 70. The trailer hitch 67 has been lowered & the swivel front wheels 68 have been raised. The articulated vacuum boom 36 has been configured into a stored position and the combination dirt pushing blade 66/jack has been raised. The vacuum container 12 access door 18 has been powered close by retracting hydraulic cylinder 63. The liquid dispensing pump 1 is shown mounted on the rear door 18 and also shows the pump 1 suction orifice access through the rear door 18 that provides access for the pump 1 to pump liquid 2 from within the vacuum container 12. a check valve 1B is shown located in the discharge of the pump 1. Check valve 1B allows the pump to share the same atmospheric conditions at that of the vacuum container 12. Because the pump 1 and the vacuum container 12 share the same atmospheric conditions the liquid 2 can flow naturally by gravity into the pump 1. A water jetter hose reel 37 is shown mounted to the rear door 18. The jetter reel may be powered and operated by remote control.

FIG. 10 shows a vacuum boring & mud recovery system preparing to clean a drainage pipe 38. A manhole cover 46 is being removed to gain access to the drainage pipe 38 by a manhole cover 46 removal attachment 47 mounted to the articulated powered vacuum conduit boom 36. A conduit 48 supplies power to the manhole cover removal attachment means 47. The manhole cover removal attachment means 47 may be an electro magnet, a suction cup or a mechanical attachment means. FIG. 10 represents yet another embodiment of the vacuum container 2 showing the vacuum container 2 mounted on an inclined slope, supported by a liquid container 8 located beneath the incline of the vacuum container 12, and mounted on a generic mobile platform. The inclined angle is sufficient to allow the contents of the vacuum container to be removed by gravity when the door 18 is opened. A filter housing 64 having air filters disposed within it, is shown mounted adjacent to the vacuum container 12 in a configuration to allow simultaneous access to it & the debris tank 12 by a single door 12. A powered telescoping cylinder 63, chosen from a linear actuator or hydraulic, or air cylinder is shown mounted within the vacuum container 12 and to the access door 18. This telescoping cylinder 63 opens or closes the access door 18.

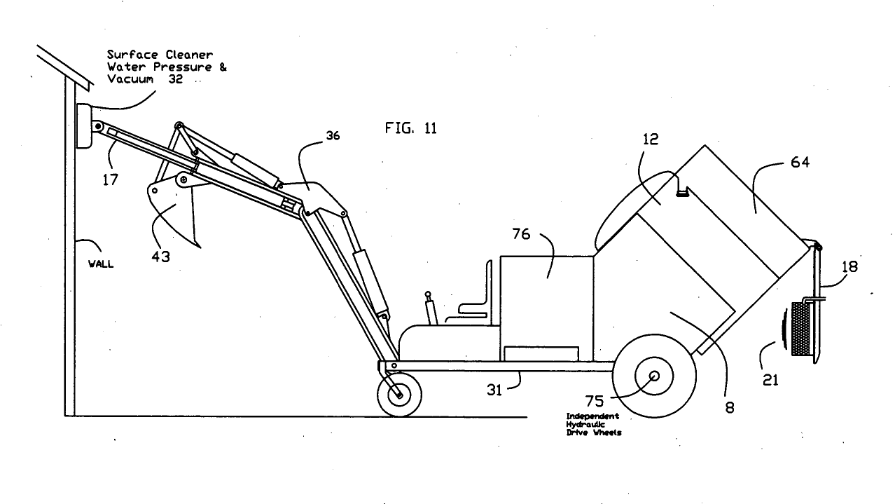

FIG. 11 Is similar to FIG. 8 with the exception that a water pressure surface cleaner 32 is shown attached to the telescoping vacuum conduit 17. The powered articulating boom 36 is shown to be placing the surface cleaner 32 an a wall that is shown to need cleaning.

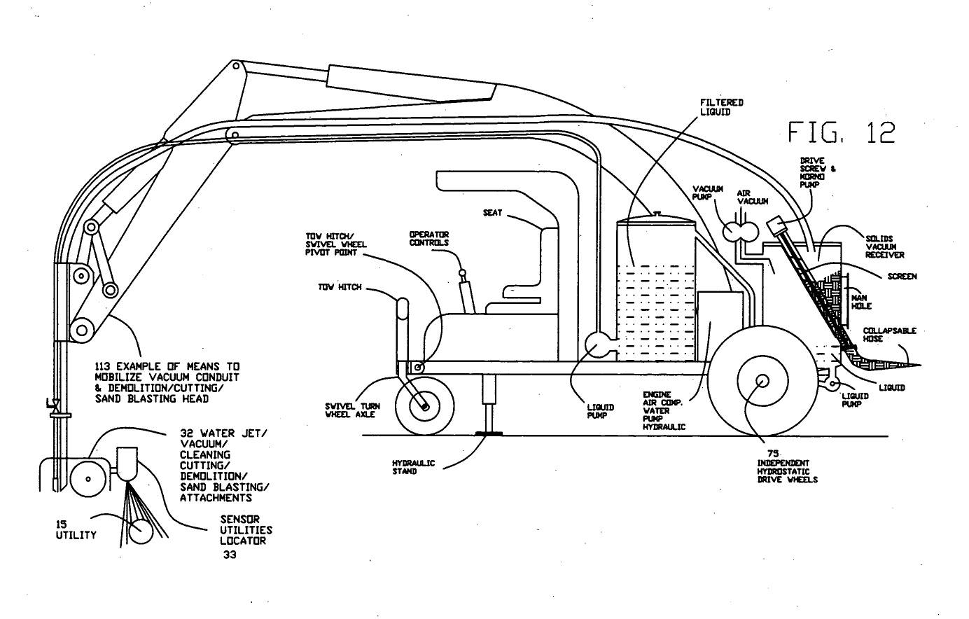

FIG. 12 Shows the side view of a Vacuum container mounted on a zero turn radius vehicle similar to drawing 8. A powered boom arm is shown placing a surface preparation tool 32 over a utility 15 to be excavated. A utility locating devise 33 is shown to be penetrating the earth to locate the utility 15. This system is shown to be multifunctional an provides the technology required to do excavating close to a utility without harming it.

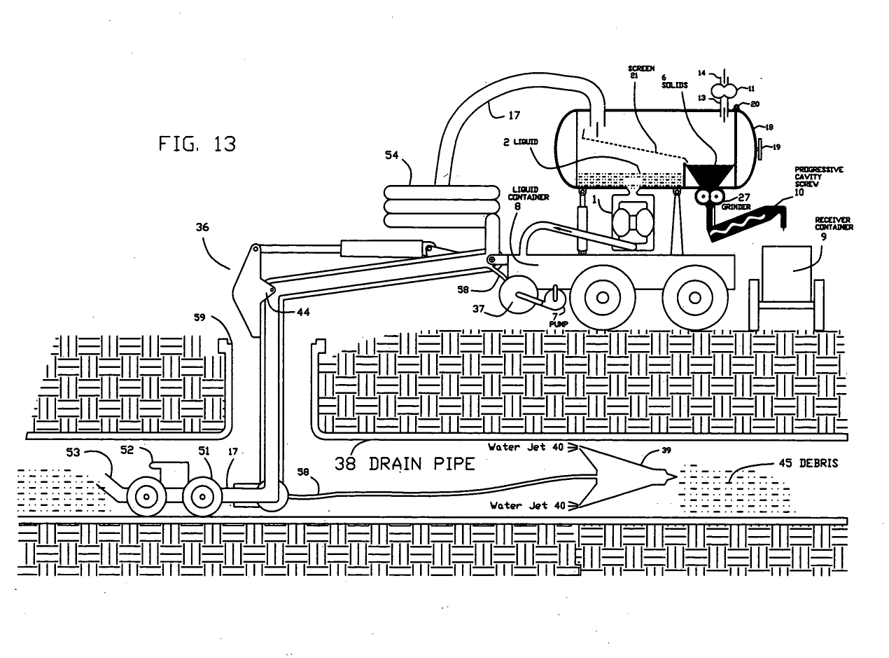

FIG. 13 shows yet another embodiment of the invention. The solids 6 are passed through a solids grinder 27 in order to reduce the solids 6 size to a predetermined size before being dispensed by a solids dispenser 10 which in this example is a progressive cavity screw. The dispensed solids are collected in solids receiver container 9 to be hauled off. The liquid 2 is shown being dispensed by liquid dispenser means 1, which in this example is a diaphragm pump. The recycled liquid 2 is pumped through hose reel 37 by transfer pump 7 to a water jetter 39 spraying a water jet 40, thus cleaning drain pipe 38 with recycled water as it moves.

The recycled liquid 2 along with solids 6 washed from drain pipe 38 are vacuumed up by the vacuum conduit 17 which is shown as an articulated powered vacuum conduit boom 36. The articulated powered boom 36 also has means to place the jetter 39 into location down a manhole 59 and into a lateral drainage conduit 38 and dispense the jetter conduit 58. In this example, telescoping cylinder 41 is used to articulate the vacuum conduit boom 36 and jetter 39. Vacuum boom structure 44 allows the vacuum conduit 17 to be rigid enough to move, support weight and force in order to articulate and operate attachments such as the vacuum conduit tractor 51 which is articulated into a starting position by the vacuum conduit boom 36. Vacuum conduit powered tractor 51 then moves vacuum conduit 17 to debris 45 to be vacuumed. Vacuum hose reel 54 unreels and retracts vacuum hose 17 as needed. Vacuum conduit tractor 51 can have a sensor controller means 52 attached so as to monitor and control the vacuuming process. Vacuum conduit tractor 51 can also be fitted with an articulating suction head means 53, which allows the vacuum conduit tractor to access debris 45 in multiple degrees. Although the articulating vacuum conduit boom 36 is shown vacuuming debris from a drain pipe, said vacuum conduit boom 36 works equally well vacuuming substances from railcars, barges, tankers, silos, or shavings and dung from the barn and stables.

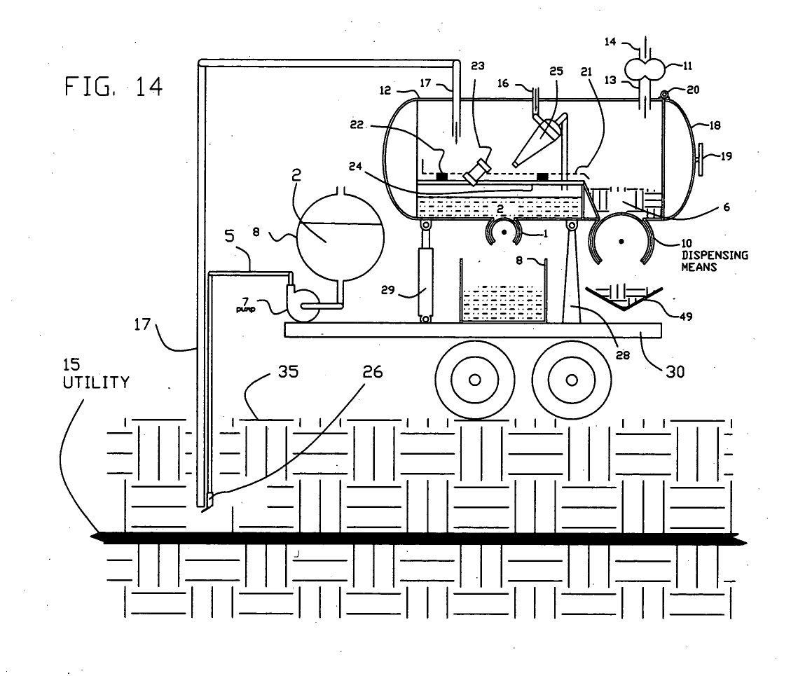

FIG. 14 shows an embodiment of the invention, being one example of various possible arrangements of apparatus within a vacuum container 12 for the purpose of accomplishing a method of separating solids 6 or liquids 2 by predetermined category and then dispensing said solids 6 or liquids 2 using a dispensing means 1 without eliminating the vacuum environment within the vacuum container 12. In FIG. 14, the apparatus of the present invention include a vacuum container 12, a vacuum producing means 11, a conduit 13 to allow air to move from vacuum container 12 to vacuum producing means 11, a second conduit 14 dispenses air from the vacuum producing means 11. Vacuum container 12 has an access door 18 having a hinge 20 and a latching means 19. Solids 6 or liquids 2 are vacuumed into vacuum container 12 by means of a vacuum conduit 17. In FIG. 14, the ground 35 is earthen dirt. Liquid 2, which has been stored in container 8, is pumped by pump 7 through pump discharge conduit 5 to a spray nozzle 26. The pressurized liquid 2 dislodges and emulsifies the ground 35 so it becomes vacuum able. The vacuum able ground 35 and liquid 2 are vacuumed through conduit 17 and into vacuum container 12. The solids 6 and liquids 2 fall onto a screen 21 which is vibrated by vibrator 23. Screen 21 is mounted on springs 22 which are supported by support means 24. Liquid 2 passes through screen 21 and is dispensed from the vacuum container 12 by means of a liquid dispenser means 1 which is shown as a rotary void style in this example. The solids 6 which are too large to pass through the vibrating screen 21 are vibrated to a solids dispensing means 10 which in this example is a rotary void style dispenser. The solids 6 are dispensed into solids conveyor 49. The vacuum container 12 is supported by a pivot arm 28 and a cylinder 29 which may be extended to dump contents out of container access door 18. The above system is mounted on a mobile platform 31 with wheels 30. FIG. 14 is shown excavating ground 35 in order to locate a utility 15 without doing damage to said utility 15.

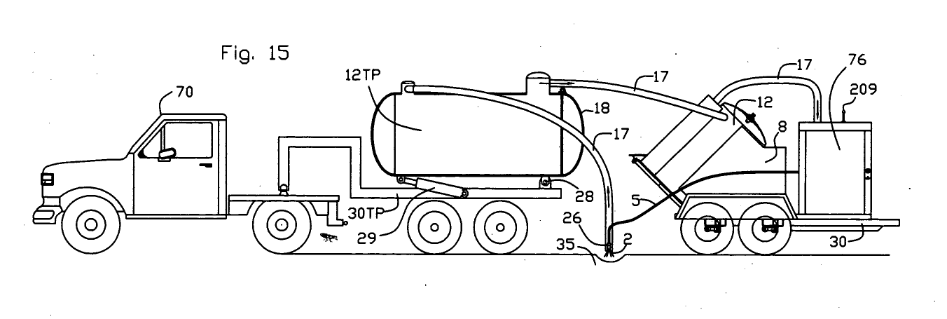

FIG. 15 shows on the right, a side view of a trailer 30 mounted power plant 76 which powers a vacuum pump and supplies a vacuum source for trailer 30 onboard vacuum container 12. Trailer 30TP is shown having a vacuum container 12TP but it does not have an onboard vacuum source. Trailer 30TP is used to transport vacuumed solids & liquids and is shown connected to a truck 70. This arrangement allows the multi-tool power-plant to remain on the job site while truck 70 hauls vacuum able materials off the job site in vacuum container 12TP. To fill vacuum container 12TP a vacuum conduit 17 is shown connected to vacuum container 12. Power plant 76 is also shown providing pressurized water 2 to the vacuum conduit 17 which is shown filling vacuum container 12TP. Vacuum container 12TP is shown to be able to be dumped by extending hydraulic cylinder 29. Container 12TP will pivot on axle 28.

FIG. 16 is a cross section side elevation of a vacuum hose 17 which may be used to vacuum excavated dirt or earthen material. The circumference wall of the vacuum hose 17 has been increased at the suction inlet to form a bell 91 shaped configuration. The bell circumference 91 is larger than the vacuum hose circumference 17 thus increasing the inlet area. An indention 92 is made into the bell circumference 91. The ratio between the vacuum hose circumference 17, the bell circumference 91 and the size of the indention 92, affects the area of the suction inlet of the vacuum hose 17 thus affecting the velocity of air and debris travel at that point. Various desired velocity characteristics may be achieved by manipulating the above mentioned ratios. Various debris 45 are vacuumed more effectively at different velocities thus the above mentioned ratios may be predetermined for best efficiency of a given debris 45 to be vacuumed.

The indention 92 may be sized so as to restrict the maximum size of debris 45 which may enter the vacuum hose 17 thus not allowing debris 45 to enter the vacuum hose 17 which would be so large as to clog the vacuum hose 17.

A liquid spray nozzle 26 which may be a pulse jet, a rotary jet, a jetter nozzle or a fixed spray jet may be placed in the indention 92. The indention 92 may be cone shaped so as to direct the nozzle 26 orifice 76 and liquid spray 2 in the direction of the center of the area to be vacuumed by the vacuum hose 17, thus the liquid spray 2 effectively loosens and makes vacuum able the dirt at the entrance of the suction end of the vacuum hose 17.

Liquid is supplied to the nozzle 26 by means of the spray nozzle hose 5.

FIG. 16B is an end view of the suction end of the vacuum hose showing how the bell circumference 791 is indented 792 in order to restrict the debris 745 size entering the hose to less than the size of the vacuum hose circumference 17.

It is recognized that while each of the figures show different types of vacuum methods, vacuum booms, different utilities power supplies, multiple tool attachment configuration, vacuum containers with different types of solid or liquid separation and dispensing, the various apparatuses are interchangeable and can replace one another. Further more, although some of the articulated powered vacuum conduit booms are shown with vacuum containers having liquid or solid dispensers, it is recognized that the articulated powered vacuum conduit boom and its attachment means can be used alone or in conjunction with any type of vacuum system.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

1. A mobile method of vacuum excavation or surface cleaning which comprises the steps of: providing a vacuum container, said vacuum container having a vacuum producing means to create a vacuum within said container, providing a conduit to vacuum liquid or solid particles into said vacuum container, providing a means to allow a gas to go through said vacuum container while leaving said liquid or solid particles within said vacuum container and providing an onboard utility power producing means consisting of an engine, a vacuum producing means, a water pump, and an electricity producing means, and said conduit to vacuum liquid or solid particles being attached on a first end to said vacuum container and on a second end to a surface cleaner and said surface cleaner having an attachment means to an electric powered wheel chair.

2. A mobile method of vacuum excavation or surface cleaning as described in claim 1, further comprising the steps of having said electric powered wheel chair connected to a utility produced on board said mobile method of vacuum excavation and said utility being chosen from a list consisting of DC electric power, AC electric power, pressurized water or vacuum producing means.

3. A mobile method of vacuum excavation or surface cleaning which comprises the steps of: providing a vacuum container, said vacuum container having a vacuum producing means to create a vacuum within said container, providing a conduit to vacuum liquid or solid particles into said vacuum container, providing a means to allow a gas to go through said vacuum container while leaving said liquid or solid particles within said vacuum container and providing an onboard utility power producing means consisting of an engine, a vacuum producing means, a water pump, and an electricity producing means, and said conduit to vacuum liquid or solid particles being attached on a first end to said vacuum container and on a second end to a flat disk wafer style valve, where in said a flat disk wafer style valve may have the added features chosen from a list consisting of, a single vacuum conduit valve, multiple conduit valve, hand powered opening or closing, powered mechanical actuation, remote controlled power actuation.

4. A mobile method of vacuum excavation or surface cleaning which comprises the steps of: providing a vacuum container, said vacuum container having a hinged access door, and said vacuum container having a vacuum producing means to create a vacuum within said container, and further providing a conduit to vacuum liquid or solid particles into said vacuum container, and providing a means to allow a gas to go through said vacuum container while leaving said liquid or solid particles within said vacuum container and providing an onboard utility power producing means consisting of an engine, a vacuum producing means, a water pump, and an electricity producing means and a hydraulic pressure means, and further comprising a hydraulic cylinder having a first end of said cylinder mounted adjacent to said vacuum container and said second end of said cylinder mounted adjacent to said access door for the purpose of opening said access door by extending said cylinder or closing said access door by retracting said cylinder, and said hydraulic cylinder further comprising a hydraulic check valve and pilot conduit control arrangement which maintains hydraulic pressure to retract said cylinder after said hydraulic pressure means stops producing hydraulic pressure.

5. A mobile method of vacuum excavation or surface cleaning as described in claim 4, wherein said mobile method is a trailer, further comprising the steps of having a Jack hammer stand mounted adjacent to said trailer frame and said stand is purposely located with its base being located below the elevation of said trailer frame and said base location being positioned at an elevation above the ground in order to place the handles of said jack hammer at approximately waste high on a man standing to remove said jack hammer, and so that said man may use a curling movement of said mans elbows to lift said jack hammer from said stand and said stand base having an attachment rod adjacently secured and said rod being sized and shaped to fits into said Jack hammer chisel receiver and said stand may have added features chosen from a list consisting of a hinged latch, lock, bungee cord, or travel security means.

6. A mobile method of vacuum excavation or surface cleaning as described in claim 4, further comprising the steps of having said conduit to vacuum liquid or solid particles being attached on a first end to said vacuum container and a second end of said conduit to vacuum liquid or solid particles having an indention sculptures to adjacently mount a water spray nozzle on the out side circumference of said second end of said conduit and within said indention.

7. A mobile method of vacuum excavation or surface cleaning as described in claim 6, further comprising the steps of having a mobile splash guard positioned adjacent to said second end of said vacuum conduit.

8. A mobile method of vacuum excavation or surface cleaning as described in claim 4, further comprising the steps of having a second mobile vacuum container mounted on a second mobile means, and said second vacuum container being dependent on said first mobile vacuum excavator's vacuum producing means as a source of vacuum for said second vacuum container.

9. A mobile method of vacuum excavation or surface cleaning as described in claim 4, further comprising the steps of having additional onboard utilities chosen from a list consisting of an air compressor, water heater an AC generator, an AC inverter, DC power source, or welder.

10. A mobile method of vacuum excavation or surface cleaning as described in claim 4, further comprising the steps of adjacently attaching auxiliary tools chosen from a list consisting of a jack hammer, rock drill, welder, submergible water pump, post driver, post puller, surface cleaner, surface grinder, saw, drill, tamp, sand blaster, an articulated powered vacuum conduit boom with sufficient structural strength to allow an operator to remotely move and control the location of the suction end of the vacuum conduit with one or more attachments adjacently attached to the boom arm, and said attachments being chosen from an earth digging bucket, a telescoping vacuum conduit, sensor to locate buried utilities, monitors and controls to operate the attachments and their function, water spray nozzle, manhole cover remover, cutting tool, pile driver, grinding tool, saw, blasting tool, surface cleaning tool, demolition tool, torque wrench, tractor to pull vacuum hose, jetter nozzle, camera, hydraulic fluid conduits, water pressure hoses, or electrical cords to operate said tools.

11. A mobile method of vacuum excavation or surface cleaning as described in claim 4, further comprising the steps of having: said vacuum debris container being mounted at an inclined slope sufficient to allow said liquid storage container to be mounted below said incline of said vacuum debris container.

12. A mobile method of vacuum excavation or surface cleaning as described in claim 4, further comprising the steps of having said vacuum debris container being mounted at an inclined slope sufficient to allow debris to empty from said debris container by gravity and to provide space for said liquid storage container to be mounted below said incline of said vacuum debris container, and further comprising the steps of: having a means of mounting a filter housing adjacent to said vacuum debris container so as to allow a single door access to both said filter housing and said vacuum debris container, and providing a means of producing a vacuum within said vacuum container and said filter housing having connecting conduits to flow air from said vacuum debris container through said filter housing to said vacuum producing means, and said filter housing having filters disposed within to remove debris from said air.

13. A mobile method of vacuum excavation or surface cleaning as described in claim 4, further comprising the steps of having a rolled screen disposed within said vacuum container, and said rolled screen arrangement means having a vibrator adjacently mounted so as to vibrate said rolled screen within said vacuum container for the purpose of resisting solids from sticking to said vibrating screen as said screen separates said liquid from said solids, whereby said solids remain outside the circumference of said vibrating screen and said liquid filter through said vibrating screen to the inside of said screen circumference and said rolled screen arrangement means having one end sealed against said vacuum container access door thus giving access to said inside of said screen through said vacuum container access opening.

14. A mobile method of vacuum excavation or surface cleaning as described in claim 13, further comprising the steps of having a first end of a solids drag bar adjacently mounted to the inside of said access door and the second end of said solids drag bar being disposed within said vacuum container where it may become imbedded within said solids as said solids accumulate, and as said hydraulic cylinder extends to open said access door said solids drag bar is pulled out of said vacuum container along with said solids.

15. A mobile method of vacuum excavation or surface cleaning as described in claim 13, further comprising the steps of having: a means to dispense liquids or solids from said vacuum container without eliminating the vacuum environment within said vacuum container.

16. A mobile method of vacuum excavation or surface cleaning as described in claim 4, further comprising the steps of having: a boom arm consisting of one or more horizontally articulated arms and one or more vertically articulated arms with an attachment means to support tools and accessories chosen from a list consisting of a water pressure supply conduit, hydraulic supply conduit, air pressure supply conduit, vacuum conduit, DC electrical supply cord, AC electrical supply cord, hydraulic cylinders to power the articulation of the boom, linear actuators to power the articulation of the boom, powered rotary screw to rotate the boom, hose reels for the utility supplies remote control means for operation, hydraulic motors, electric motors, torque wrenches, post drivers, submergible water pumps, grinders, spray nozzles, surface cleaners, surface grinders or digging buckets.
